(19) United States
(12) Patent Application Publication
(10) Pub. No.: US 2023/0159103 A1
(43) Pub. Date: May 25, 2023

(54) AUTOMOBILE CHASSIS

(71) Applicant: BlackSeries Intelligent Equipment (Weihai) Co., Ltd, Weihai (CN)

(72) Inventors: Xinna LIU, Weihai (CN); Runjia GONG, Weihai (CN); Guang XU, Weihai (CN); Xuxin DU, Weihai (CN)

(21) Appl. No.: 17/744,605

(22) Filed: May 13, 2022

(30) Foreign Application Priority Data
Nov. 23, 2021 (CN) 2021113928329

(51) Int. Cl. B62D 21/02

(52) U.S. Cl. CPC B62D 21/02

(57) ABSTRACT

Disclosed is an automobile chassis, which includes a chassis main beam, a chassis cross beam and a support cross beam. The quantity of the chassis main beams is two. The two chassis main beams are arranged in parallel. A section shape of the chassis main beam is “ [symbol] ”, and the openings of the two chassis main beams are arranged opposite. The quantity of the support cross beams is more than one. All the support cross beams are arranged between the two chassis main beams. A length direction of the support cross beam is perpendicular to a length direction of the chassis main beam. The chassis cross beam is arranged at an end of the chassis main beam, and both ends of the chassis cross beam are respectively connected and fixed with the two chassis main beams.

### CROSS REFERENCE TO RELATED APPLICATION

This patent application claims the benefit and priority of Chinese Patent Application No. 202111392832.9 filed on Nov. 23, 2021, the disclosure of which is incorporated by reference herein in its entirety as part of the present application.

### TECHNICAL FIELD

The present disclosure relates to the technical field of vehicle equipment, and more specifically, to an automobile chassis.

### BACKGROUND ART

The function of the automobile chassis is to support and carry the automobile engine and its various components and assemblies, and to receive the power of the engine to make the automobile move and ensure the normal running of the automobile. Because the automobile chassis is extremely important and needs to carry a large weight, the materials used in the automobile chassis, as well as the structural strength and rigidity, have high requirements.

At present, the chassis frame of RV adopts the frame structure composed of rectangular tube and square tube, while the chassis frame composed of rectangular tube and square tube is heavier and the cost of chassis is higher. Therefore, it is an urgent technical problem to be solved by those skilled in the art to propose a low-cost automobile chassis.

### SUMMARY

In order to solve the above problems existing in the prior art, the present disclosure provides a lightweight automobile chassis to solve the technical problem of high cost of the automobile chassis in the prior art.

The present disclosure is specifically realized through the following technical solutions.

An automobile chassis provided in the present disclosure includes a chassis main beam, a chassis cross beam and a support cross beam.

The quantity of the chassis main beams is two. The two chassis main beams are arranged in parallel. A section shape of the chassis main beam is “ [symbol] ”, and the openings of the two chassis main beams are arranged opposite.

The quantity of the support cross beams is more than one. All the support cross beams are arranged between the two chassis main beams. A length direction of the support cross beam is perpendicular to a length direction of the chassis main beam. The chassis cross beam is arranged at an end of the chassis main beam, and both ends of the chassis cross beam are respectively connected and fixed with the two chassis main beams.

In order to better implement the disclosure, further optimization is made in the above structure. Multiple through holes are arranged on the chassis main beam, and all the through holes are arranged along the length direction of the chassis main beam.

In order to better implement the disclosure, further optimization is made in the above structure. A shape of the through hole is oval or rectangular, and a length direction of the through hole is parallel to the length direction of the chassis main beam.

In order to better implement the disclosure, further optimization is made in the above structure. A spacing between two adjacent through holes is greater than the length of the through holes.

In order to better implement the disclosure, further optimization is made in the above structure. A width of the through hole is less than ½ of a height of the chassis main beam.

In order to better implement the disclosure, further optimization is made in the above structure. The width of the through hole is greater than ⅓ of the length of the through hole.

In order to better implement the disclosure, further optimization is made in the above structure. The automobile chassis further includes a traction frame. Two connecting ends of the traction frame are respectively connected and fixed with the two chassis main beams, and a traction end of the traction frame extends to a side of the chassis cross beam away from an outrigger cross beam.

In order to better implement the disclosure, further optimization is made in the above structure. A middle of the traction frame is erected on the chassis cross beam, and the traction frame is connected and fixed with the chassis cross beam through a connecting plate.

In order to better implement the disclosure, further optimization is made in the above structure. The opening of the chassis main beam is provided with a stiffener. The stiffener and the chassis main beam are integrally formed members.

In order to better implement the disclosure, further optimization is made in the above structure. Multiple outrigger cross beams for supporting outriggers or frames are arranged on a side of the chassis main beam away from the opening. A length direction of the outrigger cross beams is perpendicular to the length direction of the chassis main beam, and all the outrigger cross beams are arranged along the length direction of the chassis main beam.

To sum up, the present disclosure has the following technical effects.

The section shape of the chassis main beam in the automobile chassis is a “ [symbol] ” shape structure, and its bending moment is similar to that of the rectangular pipe. Moreover, the material consumption of the chassis main beam of this structure is less than that of the rectangular pipe, so that the amount of material used for making the chassis main beam is reduced, thereby effectively reducing the cost of the automobile chassis.

### BRIEF DESCRIPTION OF THE DRAWINGS

In order to explain the embodiments of the present disclosure or the technical solutions in the prior art more clearly, the following drawings that need to be used in the description of the embodiments or the prior art will be briefly introduced. Obviously, the drawings in the following description are only embodiments of the present disclosure. For those of ordinary skill in the art, other drawings can be obtained based on the drawings disclosed without creative work.

FIG. 1 is a structural diagram of an automobile chassis of the present disclosure.

FIG. 2 is a structural diagram of the assembly of chassis main beams in an automobile chassis of the present disclosure.

FIG. 3 is a structural diagram of a chassis main beam in an automobile chassis of the present disclosure.

FIG. 4 is a cross-sectional view of a chassis main beam in an automobile chassis of the present disclosure.

### REFERENCE MARK

1. Chassis main beam; 11. Through hole; 12. Stiffener;
2. Outrigger cross beam;
3. Chassis cross beam;
4. Support cross beam;
5. Traction frame; 51. Connecting plate.

### DETAILED DESCRIPTION OF THE EMBODIMENTS

In order to make the purpose, technical solutions and advantages of the disclosure clearer, the technical solutions of the disclosure will be described in detail below. Obviously, the described embodiments are only part of the embodiments of the disclosure, not all of them. Based on the embodiments of the disclosure, all other embodiments obtained by those skilled in the art without creative work belong to the scope of the disclosure.

In the description of the disclosure, it should be noted that unless otherwise specified, “multiple” means two or more. The orientation or positional relationship indicated by the terms “upper”, “lower”, “left”, “right”, “inner”, “outer”, “front end”, “rear end”, “head”, “tail” and so on is based on the orientation or positional relationship shown in the attached drawings, only for the convenience of describing the disclosure and simplifying the description, rather than indicating or implying that the device or element must have a specific orientation, be constructed and operated in a specific orientation. Therefore, it cannot be understood as a limitation of the present disclosure. In addition, the terms “first”, “second” and “third” are only used for descriptive purposes and cannot be understood as indicating or implying relative importance.

In the description of the disclosure, it should also be noted that unless otherwise clearly specified and limited, the terms “installation”, “connection” and “connecting” should be understood in a broad sense. For example, it can be fixed connection, removable connection, or integrated connection, mechanical connection, electrical connection, direct connection or indirect connection through intermediate media. For those skilled in the art, the specific meaning of the above terms in the disclosure can be understood according to the specific conditions.

### Embodiment

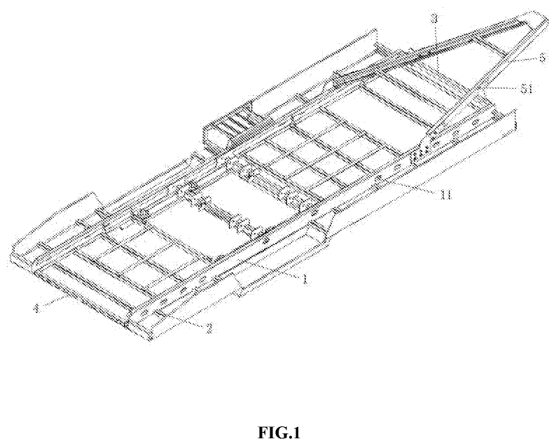

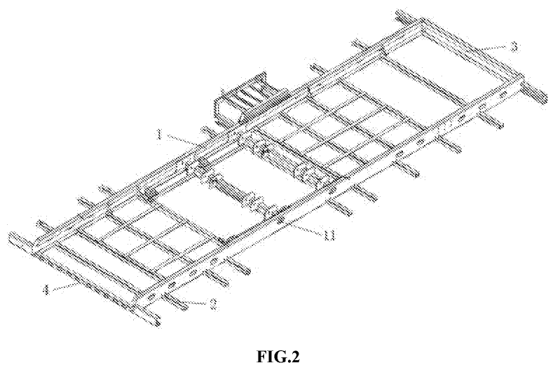

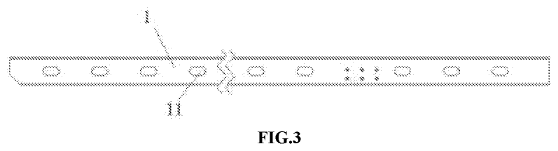

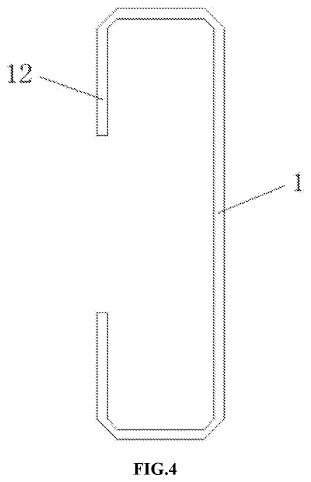

As shown in FIG. 1 to FIG. 4:

An automobile chassis includes a chassis main beam 1, a chassis cross beam 2 and a support cross beam 4.

A quantity of the chassis main beams 1 is two. The two chassis main beams 1 are arranged in parallel. A section shape of the chassis main beam 1 is “ [symbol] ”. And openings of the two chassis main beams 1 are arranged opposite.

A quantity of the support cross beams 4 is more than one. All the support cross beams 4 are arranged between the two chassis main beams 1. A length direction of the support cross beam 4 is perpendicular to a length direction of the chassis main beam 1. The chassis cross beam 3 is arranged at an end of the chassis main beam 1. And both ends of the chassis cross beam 3 are respectively connected and fixed with the two chassis main beams 1.

The section shape of the chassis main beam 1 in the automobile chassis is a “ [symbol] ” shape structure, and its bending moment is similar to that of the rectangular pipe. Moreover, the material consumption of the chassis main beam of this structure is less than that of the rectangular pipe, so that the amount of material used for making the chassis main beam 1 is reduced, thereby effectively reducing the cost of the automobile chassis.

It should be noted that the chassis main beam 1 with the above section shape of “ [symbol] ” is cold-formed equilateral channel steel or inner lipped channel steel. According to the table, when the material strength of rectangular pipe is the same as that of cold-formed equilateral channel steel or inner lipped channel steel, their bending moment is similar. However, the weight of cold-formed equilateral channel steel or inner lipped channel steel is only about ⅔ of that of rectangular pipe, so using cold-formed equilateral channel steel or inner lipped channel steel to make chassis main beam 1 can effectively reduce the cost of automobile chassis.

Preferably, multiple through holes 11 are arranged on the chassis main beam 1.

The through holes 11 are arranged in the middle of the chassis main beam 1. The maximum stress of the “ [symbol] ” shaped chassis main beam 1 is located at the upper and lower edges, while the middle is less affected. Setting the through holes 11 in the middle of the chassis main beams 1 has little impact on the performance of the automobile chassis, and can further reduce the weight of the automobile chassis and reduce the production cost of the automobile chassis.

Preferably, the multiple through holes 11 are arranged along the length direction of the chassis main beam 1 to reduce the influence of the through holes 11 on the performance of the chassis main beams 1 and make the structure of the automobile chassis more stable.

Optimally, the shape of the through hole 11 is oval.

It should be noted that the shape of the through hole 11 is not limited to an oval, but can also be set to a rectangular or circular shape. Among them, the rectangular through hole 11 can be set in the pure bending section of the chassis main beam 1, and the four top corners of the through hole 11 are chamfered. The circular through hole 11 can set the shear bending section of the chassis main beam 1 to reduce the influence of the through hole 11 on the performance of the chassis main beam 1, so as to make the structure of the automobile chassis more stable.

Optimally, a spacing between two adjacent through holes 11 is greater than the length of the through holes 11 to reduce the influence of through holes 11 on the structure of chassis main beam 1.

Optimally, the width of the through hole 11 is less than ½ of the height of the chassis main beam 1.

Optimally, the width of the through hole 11 is greater than ⅓ of the length of the through hole 11.

Optimally, the automobile chassis further includes a traction frame 5.

The traction frame 5 is a V-shaped structure, and two connecting ends of the traction frame 5 are respectively connected and fixed with the two chassis main beams 1, so that the connection between the traction frame 5 and the chassis main beam 1 is more stable.

A traction end of the traction frame 5 extends to a side of the chassis cross beam 3 away from the support cross beam 4, so that the traction device can be easily connected to the traction end of the traction frame 5 during the traction process, so as to make the traction of the vehicle equipped with the automobile chassis more convenient.

Preferably, the two connecting ends of the traction frame 5 are connected and fixed with the support main beam through bolts, which makes the installation and disassembly of the traction frame 5 more convenient, so as to facilitate the maintenance of the automobile chassis and the replacement of parts.

Optimally, the middle of the traction frame 5 is erected on the chassis cross beam 3 to avoid the deformation or fracture of the traction frame 5 caused by excessive force on the connecting ends of the traction frame 5, so as to make the structure of the traction frame 5 more stable.

Preferably, the middle of the traction frame 5 is connected and fixed with the chassis beam 3 through the connecting plate 51, so as to make the connection of the traction frame 5 more stable.

It should be noted that the connecting plate 51 is connected and fixed with the traction frame 5 and the chassis cross beam 3 through bolts, so as to make the disassembly and assembly of the connecting plate 51 more convenient.

Optimally, the opening of the chassis main beam 1 is provided with a stiffener 12 which can effectively improve the load-bearing capacity of the chassis main beam 1, so as to make the structure of the automobile chassis more stable.

Preferably, the stiffener 12 and the chassis main beam 1 are integrally formed members, so as to further improve the performance of the automobile chassis.

Optimally, multiple outrigger cross beams 2 are arranged on a side of the chassis main beam away from the opening. A length direction of the outrigger cross beams 2 is perpendicular to the length direction of the chassis main beam 1, and all the outrigger cross beams 2 are arranged along the length direction of the chassis main beam 1. The outrigger and frame can be erected on the chassis main beam 1 through the outrigger cross beams 2, so as to make the installation of the automobile chassis more convenient.

The above is only the specific embodiments of the disclosure, but the protection scope of the disclosure is not limited to this. Any skilled person familiar with the technical field can easily think of changes or replacements within the technical scope disclosed by the disclosure, which should be covered by the protection scope of the disclosure. Therefore, the protection scope of the disclosure shall be subject to the protection scope of the claims.

What is claimed is:

1. An automobile chassis, comprising a chassis main beam (1), a chassis cross beam (3) and a support cross beam (4);
wherein a quantity of the chassis main beams (1) is two, the two chassis main beams (1) are arranged in parallel, a section shape of the chassis main beam (1) is “ [symbol] ”, and openings of the two chassis main beams (1) are arranged opposite;
a quantity of the support cross beams (4) is more than one, all the support cross beams (4) are arranged between the two chassis main beams (1), a length direction of the support cross beam (4) is perpendicular to a length direction of the chassis main beam (1), the chassis cross beam (3) is arranged at an end of the chassis main beam (1), and both ends of the chassis cross beam (3) are respectively connected and fixed with the two chassis main beams (1).

2. The automobile chassis of claim 1, wherein a plurality of through holes (11) are arranged on the chassis main beam (1), and all the through holes (11) are arranged along the length direction of the chassis main beam (1).

3. The automobile chassis of claim 2, wherein a shape of the through hole (11) is oval or rectangular, and a length direction of the through hole (11) is parallel to the length direction of the chassis main beam (1).

4. The automobile chassis of claim 3, wherein a spacing between two adjacent through holes (11) is greater than the length of the through holes (11).

5. The automobile chassis of claim 4, wherein a width of the through hole (11) is less than ½ of a height of the chassis main beam (1).

6. The automobile chassis of claim 5, wherein the width of the through hole (11) is greater than ⅓ of the length of the through hole (11).

7. The automobile chassis of claim 1, further comprising a traction frame (5), wherein two connecting ends of the traction frame (5) are respectively connected and fixed with the two chassis main beams (1), and a traction end of the traction frame (5) extends to a side of the chassis cross beam (3) away from an outrigger cross beam (2).

8. The automobile chassis of claim 7, wherein a middle of the traction frame (5) is erected on the chassis cross beam (3), and the traction frame (5) is connected and fixed with the chassis cross beam (3) through a connecting plate (51).

9. The automobile chassis of claim 1, wherein the opening of the chassis main beam (1) is provided with a stiffener (12), and the stiffener (12) and the chassis main beam (1) are integrally formed members.

10. The automobile chassis of claim 9, wherein a plurality of outrigger cross beams (2) for supporting outriggers or frames are arranged on a side of the chassis main beam (1) away from the opening, a length direction of the outrigger cross beams (2) is perpendicular to the length direction of the chassis main beam (1), and all the outrigger cross beams (2) are arranged along the length direction of the chassis main beam (1).
